(19) United States
(12) Patent Application Publication
(10) Pub. No.: US 2013/0003909 A1
(43) Pub. Date: Jan. 3, 2013

(54) FILTER FOR COOLING WATER OF A PRIMARY CIRCUIT OF A NUCLEAR POWER STATION, AND A METHOD FOR FILTERING COOLING WATER

(75) Inventor: ARNE BROCKMÖLLER-MEINERS, RICKLING (DE)

(73) Assignee: AREVA NP GMBH, ERLANGEN (DE)

(21) Appl. No.: 13/495,367

(22) Filed: Jun. 13, 2012

Related U.S. Application Data
(63) Continuation of application No. PCT/EP2011/058818, filed on May 30, 2011.

(30) Foreign Application Priority Data
Jul. 15, 2010 (DE) 10 2010 031 385.8

(51) Int. Cl. G21C 19/307

(52) U.S. Cl. 376/313

(57) ABSTRACT

A filter is provided for cooling water conducting primary circuit of a nuclear power station. The power station contains a reactor container with a discharge opening for the cooling water that opens into the interior of the reactor container and being accessed when the power station is brought to a stop for an inspection shutdown. The filter contains a base carrier with an entrance, at least one filter cartridge held on the base carrier and is fluidically coupled to the entrance, and a fixing device that can be fixed to the discharge end such that the entrance couples fluidically to the discharge opening. In a method for filtering cooling water during the inspection shutdown a filter is fixed, by its fixing device, with its entrance in fluid connection with the discharge opening, the cooling water is circulated through the discharge opening, and the filter is removed from the discharge opening.

### CROSS-REFERENCE TO RELATED APPLICATION

This is a continuation application, under 35 U.S.C. §120, of copending international application No. PCT/EP2011/058818, filed May 30, 2011, which designated the United States; this application also claims the priority, under 35 U.S.C. §119, of German patent application No. DE 10 2010 031 385.8, filed Jul. 15, 2010; the prior applications are herewith incorporated by reference in their entirety.

### BACKGROUND OF THE INVENTION

### Field of the Invention

The invention relates to a filter for a primary circuit of a nuclear power station. The primary circuit conducts cooling water to be filtered. The invention also relates to a method for filtering the aforementioned cooling water.

The cooling water flowing through the primary circuit of a nuclear power station generally opens into the interior of the reactor vessel at a number of discharge openings. By way of example, discharge openings are the so-called C1- to C4-nozzles of a boiling water reactor. During the operation of the reactor, reactor installations, which for example distribute the inflowing cooling water, are generally flanged on the discharge openings. This is a feed water distributer in the case of the aforementioned boiling water reactor. During the inspection shutdown of the power station, the feed water distributer is disassembled from the C1-4-nozzles, whereupon the latter or the connection flanges thereof are freely accessible.

During the operation of a nuclear power station, debris is introduced time and time again into the cooling water of the primary circuit of a nuclear power station. By way of example, debris includes minute particles that detach from the installation or fuel elements in the reactor vessel during operation.

By way of example, it is known to use woven mats made out of metal wires in the reactor vessel of a nuclear power station with a boiling water reactor. The mats are used as insulation for the reactor pressure vessel head as a result of thermal losses. The metal wires have a diameter of 0.1 μm. The mats are introduced into the reactor vessel and there they are cut to shape. In the process, the cuttings remain in the form of wire pieces and reach the primary-side cooling water. Such minute particles are situated in the cooling water as suspended particles and, for example, cause fretting wear on the fuel elements when the power station is in operation. As a result of their small size and/or large number, the minute particles cannot be removed individually from the cooling circuit by manipulators for example, but only by appropriate filtering of the cooling water.

It would be feasible to install filters into the piping of the primary cooling circuit situated outside of the reactor vessel. However, this is a complicated process because the cooling system of the reactor is modified. To this end, expensive and complicated official approval procedures are required. Moreover, the filtration material to be filtered out, which is then collected in the filter of the piping system outside of the reactor vessel, is generally highly radioactive. Hence, a radiation source is created outside of the reactor vessel in the vicinity of the filter, which may, under certain circumstances, emit a non-negligible dose. Complicated, not unproblematic and expensive radiation-protection measures need to be taken, particularly when replacing the filter.

German patent DE 36 03 951 C2, corresponding to U.S. Pat. No. 5,243,632, discloses the practice of inserting a filtration device in place of a fuel element into the lower core support plate in order to filter circulating water from the primary circuit.

### SUMMARY OF THE INVENTION

It is accordingly an object of the invention to provide a filter for cooling water of a primary circuit of a nuclear power station, and a method for filtering the cooling water which overcome the above-mentioned disadvantages of the prior art methods and devices of this general type, resulting in an improved filter and an improved method for filtering the aforementioned cooling water.

The invention is suitable for those nuclear power stations whose discharge opening, which opens into the interior of the reactor, for cooling water is accessible during an inspection shutdown of the power station in the sense that the filter can be attached there. In other words, it must be possible to assemble a filter on the discharge opening, at least during the inspection shutdown. In the assembled state, the filter is then underwater, i.e. in the cooling water, in the interior of the reactor vessel.

The filter according to the invention has a base support, which in turn has an entrance for cooling water to be filtered. The filter moreover contains at least one filter cartridge which is held interchangeably in the base support and coupled to the entrance in a fluidic manner or fashion. According to the invention, the filter has a fixing apparatus which can be attached to the discharge opening of the reactor vessel. The attachment is brought about such that the entrance is coupled to the discharge opening in a fluidic manner.

The cooling water flowing out of the discharge opening thus flows over the entrance to the filter cartridge and flows through the latter, with the water being filtered in the process. The filtered water reemerges either at an outlet of the base support adjoining the filter cartridge in a fluidic fashion or directly at the filter cartridge. In the latter case, the outlet in other words degenerates to an outflow opening of the filter cartridge. Since the filter is situated in the interior of the reactor, the emerging water directly reaches the interior of the reactor.

Thus, in other words, if the filter is affixed to the discharge opening, cooling water flowing through the discharge opening must initially completely pass through the filter on its path through the entrance and the filter cartridge before it reaches the interior of the reactor vessel from the outlet of the filter. Thus, all cooling water flowing through the discharge opening is initially filtered and only reaches the reactor vessel in the completely filtered state. Only then does it continue on its further path in the cooling circuit.

The basic idea of the invention is to connect a filter to the freely accessible discharge openings during the inspection shutdown and to operate the cooling circuit during the inspection shutdown as well in order to conduct the cooling water through the filter and filter it during the inspection shutdown. By way of example, in the case of the aforementioned boiling water reactor, a throughput of approximately 500 l/s per connection nozzle is possible during the inspection operation. A projected filter output is approximately 100 l/s per nozzle when the filter is connected. From a purely mathematical point of view, all of the cooling water has been recycled once after a run time of approximately 6 hours in the case of such an operation in the known reactor, i.e. all of the cooling water has flown through the four filters on the C1- to C4-nozzles. As a result of a circulation time in the primary circuit throughout the whole duration of an inspection shutdown of e.g. three months, it is thus possible to remove almost all small suspended particles from the primary circuit as a result of the multiple circulations of the cooling water through the filters. No comparable concept of merely filtering the water in the primary circuit during the inspection shutdown has been disclosed.

Since the filter is only used during the inspection and not during the operation of the nuclear power station and moreover is not fixedly, i.e. during the operation, installed into the plant, there is no need for official approval. The assembly of the filter is simple and uncomplicated compared to the assembly in piping situated outside of the reactor. Advantages from a radiation-technical point of view emerge as a result of the filter being situated within the reactor core, where radioactive material is present in any case, and the filter moreover being situated underwater, specifically within the cooling water. During the filtration process, collected filtration material in the filter cartridge remains underwater, and so there is no additional dose in the nuclear power station as a result of this. Filter installation and removal take place underwater, i.e. in a radiation-protected manner. It is also possible to replace the filter cartridges completely underwater in the case of an assembled filter, and hence this is possible without the emergence of a radiation exposure.

The filter affords the possibility of filtering out debris introduced into the reactor vessel and the primary circuit, for example the aforementioned minute wires. Since the filter can remain in operation, and there can be a flow through the latter, during the entire inspection time, this results in a very high filtration capacity as a result of fluid permanently flowing through the filter. An indirect result of filtering the water is improved avoidance of fuel element damage, for example in the form of the aforementioned fretting caused by suspended particles.

As a result of arranging the filter underwater in the interior of the reactor, the filter can, like any radioactive material, be moved underwater from the reactor interior, e.g. through the transport lock, into the fuel element storage pool after completing the filtering process and, from there, be disposed of in radiation-safe manner. This applies to the filter and the filter cartridges, which may need to be replaced under certain circumstances.

In a preferred embodiment of the invention, the filter is provided for the feed water supply of a boiling water reactor. In other words, the reactor vessel thus is a boiling water reactor and the discharge opening is the feed water supply thereof, as already explained above.

In a further preferred embodiment, the base support has a flange which can be attached to the discharge opening, with the flange having the entrance. Since an installation part of the nuclear reactor is generally connected to the discharge opening during the operation of the reactor, for example the aforementioned feed water distributer is flanged on, various flanges or the like are available at the discharge openings during the disassembly of the corresponding installations during the inspection shutdown, which flanges or the like are not required at this time. In other words, the filter only needs to contain a flange or mating flange matched to the appropriate flange of the reactor. The filter is then attached to the discharge opening or the flange thereof by its flange, like the installation part assembled during operation. This ensures a particularly secure and reliable hold.

In a further preferred embodiment, the filter cartridge is aligned in the assembled state of the filter, i.e. when the latter is attached to the discharge opening in the reactor vessel, such that collected filtration material is contained in the filter cartridge in the gravitational direction. In other words, as a result of this, the filter cartridge is embodied such that filtration material can neither escape from the filter nor return to the primary circuit when the cooling circuit is switched off. As a result of this, an additional retention device for collected filtration material in the filter cartridge is superfluous. By way of example, if the filter cartridge has a design like a hollow cylinder and a blind hole, with an entry opening at the one longitudinal end, the filter or the cartridge is constructed such that the entry opening always points upward in the gravitational direction, i.e. forms the highest point of the filter cartridge.

In a further preferred embodiment, the filter or the filter cartridge is embodied such that the filter cartridge can, in the assembled state of the filter on the discharge opening, be removed from the base body such that the collected filtration material is contained in the cartridge in the gravitational direction during the replacement. In other words, the filter is configured such that the filter cartridge need not be tilted against the gravitational direction during the removal such that filtration material could escape. By way of example, an aforementioned cylindrical cartridge with an upwardly directed entry opening can also be removed from the filter in a vertical upward direction. As a result, the cartridge need not be tilted in the process.

In a further preferred embodiment, the inlet is, in the assembled state of the filter, arranged on the underside of the filter. By way of example, this is necessary if the discharge opening points upward, i.e. against the gravitational direction, and the filter must therefore be placed on the former. The filter then contains a rising pipe leading to the upper side of the filter from the inlet, which rising pipe in turn opens into the filter cartridge from the upper side. As a result, an inlet of the filter on the underside can be combined with the aforementioned advantages that filtration material collects in the filter cartridge in the gravitational direction and that the fluid always passes through the filter in the gravitational direction and hence filtration material can collect in the gravitational direction. The filter cartridges are then, for example, arranged level with the rising pipes in the filter and, in the case of a plurality of filter cartridges, a distributer leading from the rising pipe to the filter cartridges is placed onto the filter from above.

In a preferred embodiment, the filter cartridge has a filter element matched to the desired filtration material. By way of example, in the case of a nuclear power station, there is the specific object of filtering out the aforementioned wire debris from a wire with a diameter of 3 μm. By way of example, use can then be made of a filter which filters out all parts greater than 1 μm from the cooling water. The filters to be used are variable.

According to the method of the invention, the entrance of a filter according to the invention, as explained above, is attached to the discharge opening in a coupling manner by the fixing apparatus of the filter during the inspection shutdown of the power section. The cooling water is then circulated through the discharge opening. After the filter process has taken place, the filter is once again removed from the discharge opening and out of the reactor vessel before the inspection shutdown is completed.

The method according to the invention, together with its advantages, was already explained in the context of the filter according to the invention.

According to a preferred embodiment of the method, the quantity of cooling water is circulated through the filter a number of times. In doing so, all of the cooling water in particular is filtered a number of times if respectively one filter is attached to all discharge openings that open into the interior of the reactor.

In a preferred embodiment variant, the cooling water circulation is interrupted, a filter cartridge filled with filtration material is removed from the filter and is disposed of underwater. In exchange, a new filter cartridge is inserted into the filter and the cooling water circulation is resumed. As a result, use can be made of e.g. smaller filter cartridges with a smaller filtration material capacity. As a result, the filter has a smaller installation space.

Other features which are considered as characteristic for the invention are set forth in the appended claims.

Although the invention is illustrated and described herein as embodied in a filter for cooling water of a primary circuit of a nuclear power station, and a method for filtering cooling water, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a nuclear power station during an inspection shutdown with a section through a filter according to the invention;

FIG. 2 is a perspective view of an alternative filter according to the invention in a spatial illustration;

FIG. 3 is a perspective view of a lower part of the filter from FIG. 2 in an illustration as per FIG. 2;

FIG. 4 is a perspective view of an upper part of the filter from FIG. 2 in an illustration as per FIG. 2; and

FIG. 5 is a sectional view through a filter cartridge used in the filter from FIG. 2.

### DETAILED DESCRIPTION OF THE INVENTION

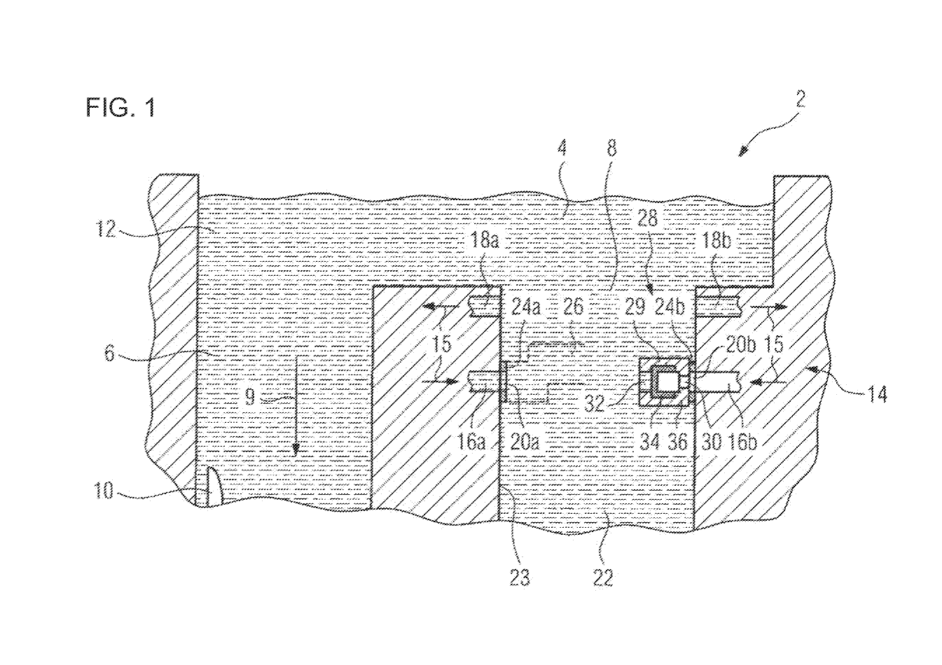

Referring now to the figures of the drawing in detail and first, particularly, to FIG. 1 thereof, there is shown a section from a nuclear power station 2, specifically a reactor vessel 4 thereof and a fuel element storage pool 6 adjoining the latter. The nuclear power station 2 is in an inspection shutdown state, which is why a reactor vessel head 10 was removed from an upper opening 8 of the reactor vessel 4—as seen in a gravitational direction 9—and temporarily stored in the fuel element storage pool 6.

The reactor vessel 4 has a primary circuit 14, through which cooling water 12 circulates during operation or else during the inspection shutdown. As a result of the inspection shutdown, the whole illustrated part of the nuclear power station 2 has been flooded with cooling water 12. The primary circuit 14 includes feed water lines 16a, 16b and main steam pipes 18a, 18b, which are attached to the reactor vessel 4. Arrows 15 in FIG. 1 illustrate the flow directions of the cooling water 12 through the primary circuit 14. During the operation of the primary circuit, cooling water 12 enters an interior 22 of the reactor vessel 4 through the discharge openings 20a, 20b of the feed water lines 16a, 16b. Of the respective four openings distributed in the circumferential direction of the reactor vessel 4, only respectively two are illustrated in FIG. 1.

The discharge openings 20a, 20b are situated on an internal wall 23 of the reactor vessel 4 and respectively have a flange 24a, 24b to which a nuclear component 26 in the form of a feed water distributer is connected during operation of the nuclear power station 2, into which nuclear component all of the cooling water 12 supplied through the feed water lines 16a, 16b flows. The nuclear component 26 is removed during the inspection shutdown, which is why it is only illustrated using dashed lines in FIG. 1.

According to the invention, a filter 28 is attached to each of the discharge openings 20a, 20b during the inspection shutdown (in FIG. 1 this is only illustrated for the discharge opening 20b). The filter 28 has a base support 29. On the latter, provision is made for an entrance 30 and an exit 32. A filter cartridge 34 has been connected in fluidic terms between the entrance 30 and exit 32 and it is held in the base support 29 in a replaceable manner. Moreover, the filter 28 or the base support 29 has a fixing apparatus 36, by which it is attached to the discharge opening 20b. The filter 28 or the attachment thereof is configured such that all of the cooling water 12 flowing into the reactor vessel 4 through the discharge opening 20b first of all flows through the entrance 30 and the filter cartridge 34 and only reaches the interior 22 of the reactor vessel 4 through the exit 32. In other words, all the cooling water 12 flowing in through the discharge opening 20b is filtered by the filter 28.

The primary circuit 14 is configured such that it circulates all the cooling water 12 of the primary circuit 14 available in the nuclear power station 2. According to the invention, respectively one filter 28 is connected to each of the four discharge openings 20a, 20b. Hence all of the cooling water 12 in the primary circuit 14 is filtered when the cooling water 12 is circulated.

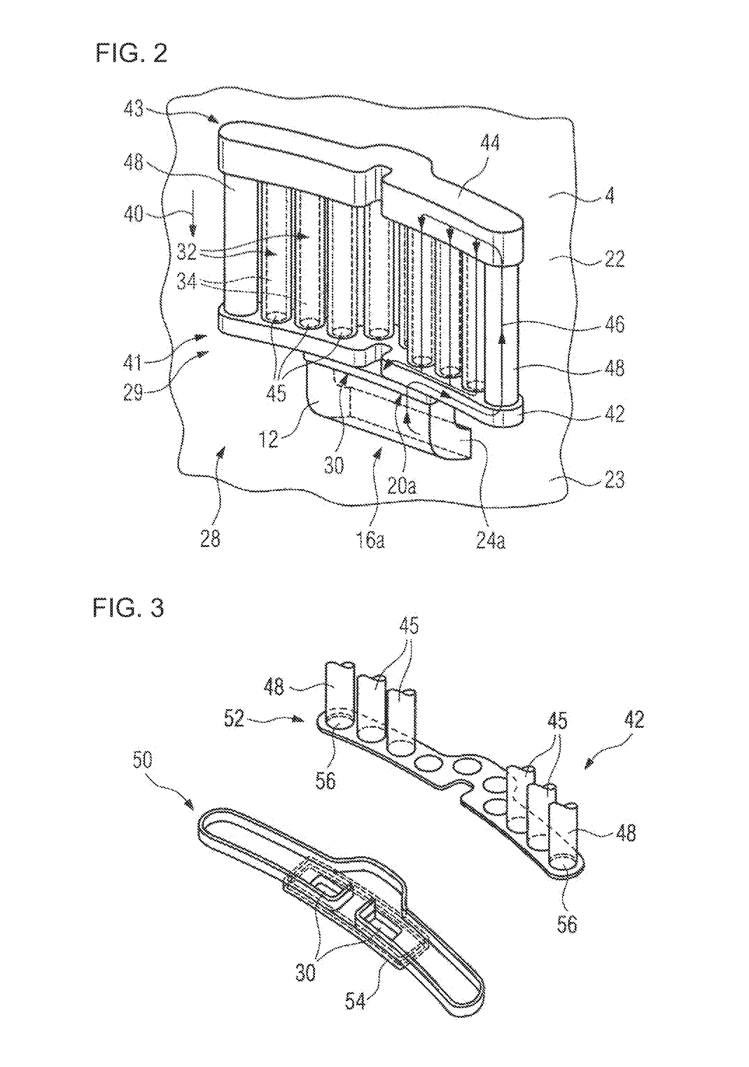

FIG. 2 shows the reactor vessel 4 from FIG. 1, or the interior wall 23 thereof, with a feed water line 16a with an alternative configuration. It is bent upward at right angles in the interior 22 of the reactor vessel 4, i.e. against the gravitational direction 9, and so the discharge opening 20a is situated at the horizontal upper end of a hollow flange 24a, which conducts cooling water 12 in the interior thereof. The filter 28 once again has the entrance 30 coupled to the discharge opening 20a. Here, eight filter cartridges 34—illustrated by a dashed line—are held in the base support 29. In this embodiment, the filter 28 or the base support 29 has a lower part 42 containing the entrance 30 on its underside 41 and an upper part 44 on its upper side 43. In this embodiment, the filter cartridges 34 are held in hollow cylindrical filter guides 45, which are attached between the lower part 42 and the upper part 44.

During operation of the primary circuit 14, cooling water 12 flows through the flange 24a and, in the direction of the arrows 46, through the discharge opening 20a and the entrance 30, through the lower part 42 and to the upper part 44 in two rising pipes 48 attached at the ends of the filter 28. The upper part guides the cooling water 12 into the eight filter cartridges 34, with the water therefore flowing through the latter in the gravitational direction 9. The rising pipes 48 and filter guides are welded to the upper part 44 and lower part 42, and form the base support 29 as a stable unit with these parts.

The cooling water 12 flows through the filter cartridges 34 and leaves the filter 28 at the cylinder barrel of the filter guides 45. Hence, in the current case, there is no object-type exit in the proper meaning of the word through which the cooling water 12 leaves the filter 28. The exit 32 is rather formed by discharge openings of the filter guides 45 distributed over the area of the cylinder barrel. Since the filter 28 is situated within the interior 22 of the reactor vessel 4, the emerging water nevertheless directly reaches the reactor interior. The arrows 46 have only been illustrated for four of the eight filter cartridges 34.

FIG. 3 shows a detailed view of the lower part 42, specifically that the latter is constructed from an attachment 50 and a lower plate 52. The attachment 50 first of all has a flange 54 as the fixing apparatus 36, which flange, as a mating flange, is matched to the flange 24a of the reactor vessel 4 in order to be assembled thereon. The attachment 50 moreover contains the entrance 30 in the form of two through-holes. When the filter 28 is assembled, the lower plate 52 is inserted onto the attachment 50 such that a flow channel for cooling water 12 is created below the plate and leads from the entrance 30 to the two through-holes 56 arranged at the ends of the lower plate 52. The rising pipes 48 are attached on the through-holes 56. The eight filter guides 45, into which the filter cartridges 34 are inserted, are attached to eight recesses 58 which do not, however, form a passage through the lower plate 52.

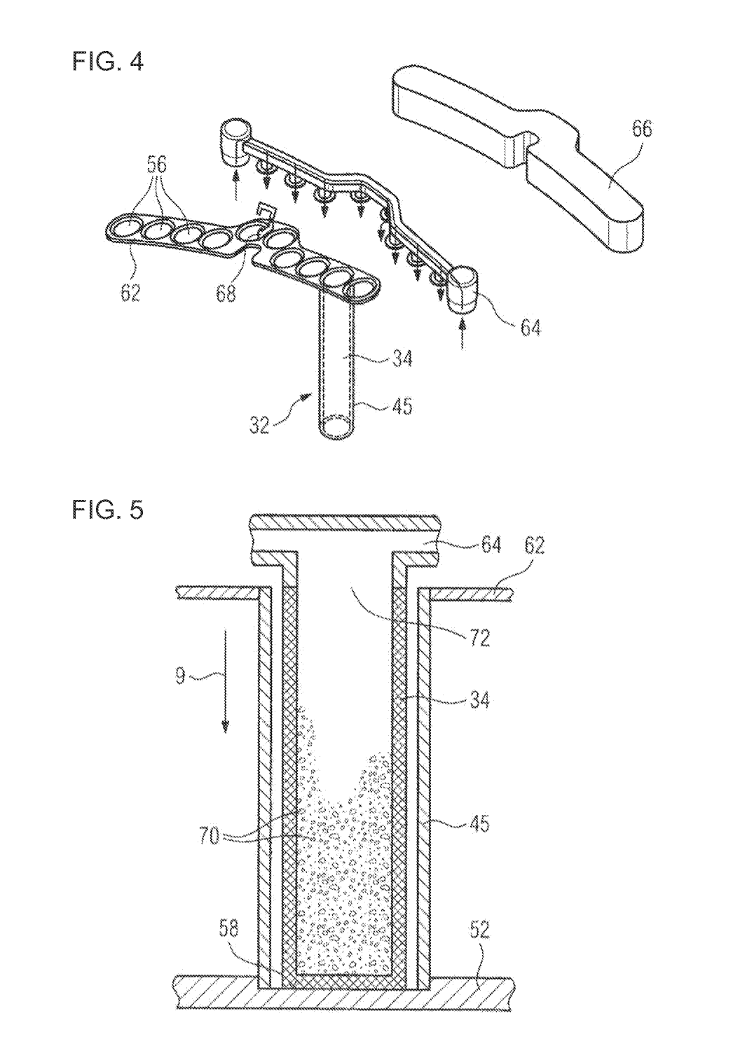

FIG. 4 shows the design of the upper part 44. The latter is composed of an upper plate 62, a distributer 64 and a cover sheet 66. In contrast to the lower plate 52, the upper plate 62 has through-holes 56 both at the attachment sites for the rising pipes 48 and at the positions for the filter guides 45. Attachment 50, lower plate 52, rising pipes 48, filter guides 45 and upper plate 62 are welded together and form the base support 29. The distributer 64 should be placed onto the base support 29 in a detachable fashion. This makes it possible to be able to insert the eight filter cartridges 34 into the eight through-holes 56, situated on the inside, of the upper plate 62. The distributer 64 is subsequently put on and held with the aid of a central fastener 68. In doing so, the distributer 64 connects to both the rising pipes 48 and the eight filter cartridges 34 in a sealing manner in order to guide the cooling water 14.

Subsequently, the cover sheet 66 is still put on and hence the filter 28 is completed. The distributer 64 thus serves to distribute the cooling water 12, which is flowing in from the ends in the direction of the arrows 46, from the rising pipes 48 among the eight filter guides 45 or filter cartridges 34.

FIG. 5 shows a detailed view and section of the filter guide 45 with an inserted filter cartridge 34 in the assembled state of the filter 28 within the reactor vessel 4. Filtration material 70 collects in the filter cartridge 34 during the filtering process. The filter cartridge is oriented such that the filtration material 70 is contained in the filter cartridge 34 in the gravitational direction 9 even if the primary circuit 14 is switched off, and so it can no longer escape therefrom. The filtration material cannot return to the primary circuit 14 in this manner.

The filter cartridges 34 are replaced while the whole filter 28 is attached to the flange 24a. In order to replace the filter cartridge 34, the cover sheet 66 is removed and the distributer 64 is detached from the central fastener 68 and removed. The filter cartridge 34 can then be removed vertically upward from the filter guide 45, against the gravitational direction 9, and does not have to be tilted against the gravitational direction 9 in the process. This also prevents filtration material 70 from escaping through the entrance opening 72 during the replacement of the filter cartridges 34 and being able to reach the interior 22 of the reactor vessel 4.

After inserting new filter cartridges 34, the filter 28 is once again made complete by attaching the distributer 64 and the cover sheet 66. The entire process of replacing the filter cartridges 34 occurs underwater, i.e. within the cooling water 12. The filter cartridges 34 filled with the in part highly radioactive filtration material 70 can for example be transferred to the fuel element storage pool 6 and be disposed of from there. All this can occur entirely underwater in order to avoid radiation exposure in the power station 2.

1. A filter for a cooling water conducting primary circuit of a nuclear power station having a reactor vessel with a discharge opening for the cooling water opening into an interior of the reactor vessel and being accessible during an inspection shutdown of the nuclear power station, the filter comprising:
a base support having an entrance;
at least one filter cartridge held interchangeably on said base support and coupled to said entrance in a fluidic manner; and
a fixing apparatus for attaching to the discharge opening such that said entrance is coupled to the discharge opening in a fluidic manner.

2. The filter according to claim 1, wherein the reactor vessel is a boiling water reactor and the discharge opening is a feed water supply thereof.

3. The filter according to claim 1, wherein said base support contains a flange which can be attached to the discharge opening and has said entrance.

4. The filter according to claim 1, wherein said filter cartridge is aligned in an assembled state such that collected filtration material is contained therein in a gravitational direction.

5. The filter according to claim 4, wherein said filter cartridge can, in the assembled state, be removed from said base support such that the collected filtration material is contained in said filter cartridge in the gravitational direction.

6. The filter according to claim 1, further comprising a rising pipe, said entrance is, in an assembled state, situated on an underside of the filter in a gravitational direction, with said rising pipe leading to an upper side from said entrance and opening into said filter cartridge from an upper side.

7. The filter according to claim 1, wherein said filter cartridge has a filter element matched to a desired filtration material.

8. A method for filtering cooling water of a primary circuit of a nuclear power station having a reactor vessel with a discharge opening for the cooling water opening into an interior of the reactor vessel and accessible during an inspection shutdown of the nuclear power station, in which, during the inspection shutdown comprises the steps of:
providing a filter containing a base support having an entrance, at least one filter cartridge held interchangeably on the base support and coupled to the entrance in a fluidic manner, and a fixing apparatus;
attaching the entrance of the filter in a fluidic manner to the discharge opening in a coupling manner by means of the fixing apparatus of the filter;
circulating the cooling water through the discharge opening; and
removing the filter from the discharge opening.

9. The method according to claim 8, which further comprises circulating all of the cooling water through the filter a number of times.

10. The method according to claim 8, which further comprises:
interrupting a circulation of the cooling water;
removing the filter cartridge filled with a filtration material from the filter position under the cooling water;
in exchange, inserting a new filter cartridge into the filter; and
continuing a circulation of the cooling water.
